(19) United States
(12) Patent Application Publication
(10) Pub. No.: US 2008/0075515 A1
(43) Pub. Date: Mar. 27, 2008

(54) Ergonomic and Key Recognition Advantage by Numeric Key Elevation

(76) Inventor: William Thomas Large, Long Beach, NY (US)

Correspondence Address: MEREDITH & KEYHANI, PLLC, 330 MADISON AVE., 6TH FLOOR, NEW YORK, NY, 10017, US

(21) Appl. No.: 11/856,583

(22) Filed: Sep. 17, 2007

Related U.S. Application Data
(60) Provisional application No. 60/827,040, filed on Sep. 26, 2006.

(51) Int. Cl. B41J 5/00

(52) U.S. Cl. 400/472

(57) ABSTRACT

A keyboard having an first mode and an second mode, the keyboard comprising: a plurality of keys; a switching means for switching between a first mode and a second mode; a height adjustment means in communication with the switching means and the plurality of keys, wherein said height adjustment means raises and lowers the plurality of keys according to the switching means; wherein the keys when pressed individually in first mode have a first output and are at a first height and wherein the keys when pressed individually in second mode have a second output and are at a second height that is different than the first height.

This application claims priority to provisional application No. 60/827,040 filed Sep. 26, 2006 and entitled “Ergonomic and Key Recognition Advantage by Numeric Key Elevation”.

This application relates generally to computer peripheral technology and more specifically the keyboards for computers.

It has long been the convention to add an additional and separate numeric keypad to desktop computer keyboards; typically to the right of the keyboard so biased to those of right handed dexterity. Laptop computer design, for the conservation of space, typically employs the use of dual function keys and a “number lock” key so as to convert existing alphanumeric keys into numeric keys only in a layout that is more akin to that of a calculator, or separate numeric keypad. This is more instinctive to those, such as accounts clerks and data processors, who frequently and for extended periods make numeric input only.

Good ergonomic practice requires that the arm should not, for extended periods, be abducted (extended to the side and away from the body) at an angle greater than 20′ as measured from an imaginary line drawn forward of the body at an angle of 90′ to the outer shoulder (see diagram 1 below). Consequently the design of desktop keyboards that include a separate numeric keypad extend the “keypad” side of that keyboard so that any input device that is placed next to it too frequently requires that the user to use that device at angles exceeding the target 20′ of abduction. This is often made worse by the fact that the user's point of reference when setting up a workstation is the viewing monitor and thereby they align themselves and the alphanumeric section of keyboard central to the monitor. The result is the location of the keypad edge of the keyboard even further to the right with the commensurate displacement of the input device even further into the “over abduction” zone (see diagram 1 below).

Most laptop keyboard designs, and some standalone “keypad-less” keyboards that recognize the abduction problem stated above, do not employ a separate numeric keypad. In order to facilitate a more “usual” input experience, for numeric input intensive users, they utilize the dual key functionality described above in the “calculator like” layout. Typically and for example, upon activation of the numeric key lock, the keys responding to the letters U, 1 and 0 become the numbers 4, 5 and 6 respectively. Likewise J, K, L to 1, 2 and 3 respectively and so on and so forth with other keys becoming functions such as + (plus) and − (minus) etc on other keys. This orientation allows for the upper, and linearly laid out, numeric keys of 1 through 0 to be utilized, with the numeric keys 7, 8, 9 as is. However the one major drawback with this arrangement is that visual recognition of numeric keys is not easy, especially as the key markings, for the secondary numeric functions, are typically mute and are further obscured in a “sea” of other keys.

The present invention solves the long felt need for an ergonomic and easy to see keyboard orientation.

### SUMMARY OF THE INVENTION

The present invention relates generally to peripheral input devices and in particular to keyboard input devices.

According to one embodiment of the present invention, a keyboard having an numeric mode and an alphabetic mode is provided, the keyboard comprising: a plurality of keys; a switching means for switching between numeric mode and alphabetic mode; a height adjustment means in communication with the switching means and the plurality of keys, wherein the height adjustment means raises and lowers the plurality of keys according to the switching means; wherein the keys when pressed individually in numeric mode have a first output and are at a first height and wherein the keys when pressed individually in alphabetic mode have a second output and are at a second height that is different than the first height.

According to another embodiment, a keyboard having an numeric mode and an alphabetic mode is provided, the keyboard comprising: a plurality of keys; a switching means for switching between numeric mode and alphabetic mode; a height adjustment means in communication with the switching means and the plurality of keys, wherein the height adjustment means raises and lowers the plurality of keys according to the switching means; a display on each of said plurality of keys, the display having a first display and a second display; wherein the keys when pressed individually in numeric mode have a first output, first display and are at a first height and wherein the keys when pressed individually in alphabetic mode have a second output, second display and are at a second height that is different than the first height.

These and other features, aspects and advantages of the present invention will become better understood with reference to the following drawings, description and claims.

### BRIEF DESCRIPTION OF THE DRAWINGS

FIG. 1 depicts the problem sought to be solved;

FIG. 2 depicts a keyboard according to the present invention;

FIG. 3 depicts a keyboard display according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

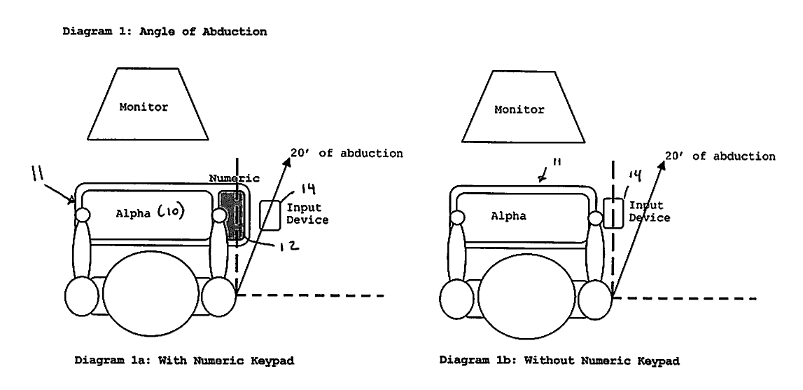

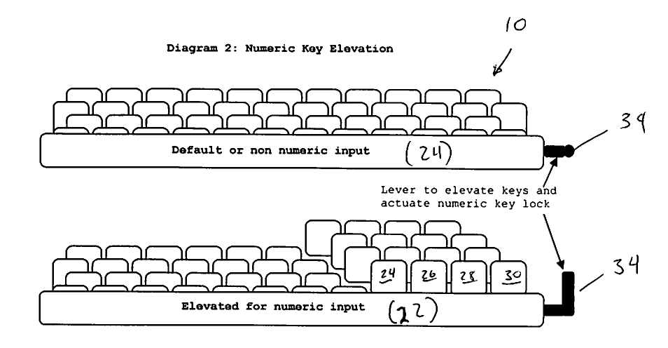

As shown in FIG. 1a, keyboards (11) often have a numeric set (12) of keys to the left of the alpha (10) keys. This is to allow users to easily type in numbers. However, the problem is that the placement of the keyboard causes the hand to actuate at a damaging angle of abduction. The present invention solved this problem by turning allowing the alphanumeric keys to transform into numeric keys. FIG. 1b depicts that the input device (14) is further towards center when the separate numeric keys are removed from the keyboard (11). This results in not only the keying of numeric number being closer to center, but also the input device (14) which may be a mouse being closer to center. As shown in FIG. 2, and according to one embodiment, a keyboard (10) having an numeric mode (22) and an alphabetic mode (24) the keyboard comprising: a plurality of keys (e.g. 24, 26, 28, 30); a switching means (34) for switching between numeric mode (22) and alphabetic mode (24); a height adjustment means (34) in communication with switching means (34) and the plurality of keys (e.g. 24, 26, 28, 30), wherein the height adjustment means raises (34) and lowers the plurality of keys (e.g. 24, 26, 28, 30) according to the switching means (34). The keys when pressed individually in first mode (which may be numeric) have a first output and are at a first height and wherein the keys when pressed individually in second mode (which may be alphabetic) have a second output and are at a second height that is different than the first height. For example, key 24 may be “,” in alphabetic mode and “1” in numeric mode. It should be understood that the term alphabetic mode refers to standard mode, while it does not only refer to alphabetic numerals. Alphabetic mode would include any standard keys, such as “|” “|”, “{”, “}”. Numeric mode would include keys used in numeric functions such as “1”, “2”, “3”, “*”, “−”, “+”, “enter”, “\”. A display (100) may be on each of the plurality of keys, the display having a first display (102) and a second display (104) and the first display (102) is in first mode and the second display (104) is in second mode. There may be a processor for receiving an output signal by the plurality of keys and associating a character with the output signal. The plurality of keys may comprise sixteen keys arranged in an array having four columns and four rows. It should be understood the keys may be of different sizes so the columns may not form standard columns, but rather staggered columns. The plurality of keys may have a transparent finger receipt portion (106) and the display (100) may be viewable through the transparent finger receipt portion (106). The plurality of keys may be arranged in an array at the far right side of the keyboard. This is particularly suitable for right handed users. The plurality of keys may also be arranged in an array at the far left of the keyboard. This may be particularly suitable for left handed users. The invention herein described solves the ergonomic problem of excessive abduction required to use an input device when using a keypad bearing keyboard and also the low visual and tactile identification of non keypad bearing keyboards by mechanically elevating those keys assigned to numeric key functionality in a “keypad-less” keyboard (see FIG. 2).

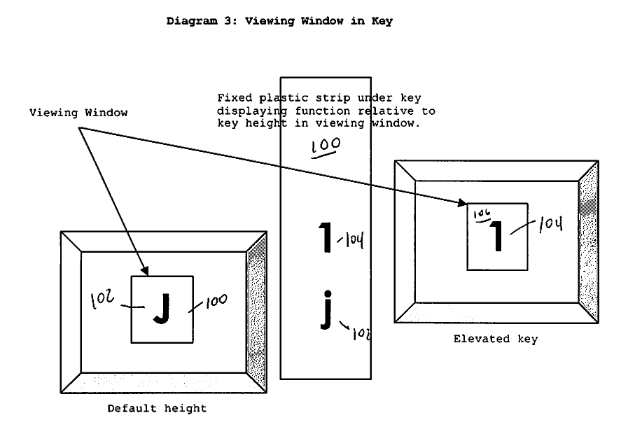

The placement of a lever (32) or switch as a switching means, should motorization of the mechanical lifting process be had, acts to both elevate the numerically functioning keys above the height of the remaining keys while at the same time actuating the “numeric lock” key function as per the conventional keyboard design of the present. The mechanical elevating means would raise the plurality of keys. For example, this may be a screw attached to the bottom of the key that raises and lowers the key. In addition the visual identification of the numeric keys may be enhanced by either: The new numeric function assigned to that key being changed in window in the key (See FIG. 3) or by the use of LED's, behind a graphic or themselves forming the key notation or other electrically mediated visually cognoscente means or by tactile means for those with visual impairment. For example, the display may be brail.

It should be understood that the foregoing relates to preferred embodiments of the invention and that modifications may be made without departing from the spirit and scope of the invention as set forth in the following claims.

I claim:

1. A keyboard having a first mode and a second mode, said keyboard comprising:
a plurality of keys;
a switching means for switching between said first mode and said second mode;
a height adjustment means in communication with said switching means and said plurality of keys, wherein said height adjustment means raises and lowers said plurality of keys according to said switching means;
wherein said keys when pressed individually in first mode have a first output and are at a first height and wherein said keys when pressed individually in second mode have a second output and are at a second height that is different than said first height.

2. A keyboard as in claim 1, further comprising:
A display on each of said plurality of keys, said display having a first display and a second display and said first display is in first mode and said second display is in second mode.

3. A keyboard as in claim 1, wherein said plurality of keys comprise sixteen keys arranged in an array having four columns and four rows.

4. A keyboard as in claim 1, wherein said plurality of keys has a transparent finger receipt portion and said display is viewable through said transparent finger receipt portion.

5. A keyboard as in claim 1, further comprising a processor for receiving an output signal by said plurality of keys and associating a character with said output signal.

6. A keyboard as in claim 1, wherein said plurality of keys are arranged in an array at the far right side of said keyboard.

7. A keyboard as in claim 1, wherein said plurality of keys are arranged in an array at the far left of said keyboard.

8. A keyboard as in claim 1, further comprising a mechanical elevating means for raising said plurality of keys.

9. A keyboard having an numeric mode and an alphabetic mode, said keyboard comprising:
a plurality of keys;
a switching means for switching between said numeric mode and said alphabetic mode;
a height adjustment means in communication with said switching means and said plurality of keys, wherein said height adjustment means raises and lowers said plurality of keys according to said switching means;
a display on each of said plurality of keys, said display having a first display and a second display;
wherein said keys when pressed individually in numeric mode have a first output, first display and are at a first height and wherein said keys when pressed individually in alphabetic mode have a second output, second display and are at a second height that is different than said first height.

10. A keyboard as in claim 9, wherein said plurality of keys comprise sixteen keys arranged in an array having four columns and four rows.

11. A keyboard as in claim 9, wherein said plurality of keys has a transparent finger receipt portion and said display is viewable through said transparent finger receipt portion.

12. A keyboard as in claim 9, further comprising a processor for receiving an output signal by said plurality of keys and associating a character with said output signal.

13. A keyboard as in claim 9, wherein said plurality of keys are arranged in an array at the far right side of said keyboard.

14. A keyboard as in claim 9, wherein said plurality of keys are arranged in an array at the far left of said keyboard.

15. A keyboard as in claim 10, further comprising a mechanical elevating means for raising said plurality of keys.
